(19) United States
(12) Patent Application Publication
(10) Pub. No.: US 2006/0223369 A1
(43) Pub. Date: Oct. 5, 2006

(54) Device with hinged USB port

(76) Inventor: Bo Zheng, Hong Kong (HK)

Correspondence Address: Mr. Eric Chan, 42 Pin Oaks Drive, Phoenixville, PA, 19460, US

(21) Appl. No.: 11/095,604

(22) Filed: Apr. 1, 2005

(51) Int. Cl. H01R 13/648

(52) U.S. Cl. 439/607

(57) ABSTRACT

The present invention relates to a device with hinged USB connector, in which electric power or data is supplied via a computer to the USB connector, thereby providing power or data to the device. One or more ends of the device are connected to a USB connector in a hinged manner. At the foldable end of the device, there is a recess in the centre which forms a receiving slot, on each of the two sides of which, there is an insertion hole for insertion of a hinge shaft; the USB connector has an integrally formed protruding part, which corresponds to and is inserted into the receiving slot and has a through hole for insertion of the hinge shaft, which connects the USB connector and the device. The device can be a lighting device, UBS drive, MP3, blue-tooth device, anion generator, charger or mini digital camera.

### BACKGROUND OF THE INVENTION

The present invention relates to a device with USB connector and more particularly pertains to a device with hinged USB connector. The device can be a lighting device, USB drive, MP3, blue-tooth device, anion generator, charger or mini digital camera.

Conventional USB connectors are generally used for plugging in computer apparatus. USB connectors may also be movably connected to a lighting device, UBS drive, MP3, blue-tooth device, anion generator, charger or mini digital camera. However, to date there is no USB connector available which connects to a device in a hinged manner and can circumrotate around the device.

### BRIEF SUMMARY OF THE INVENTION

In view of the aforesaid disadvantages now present in the prior art, the present invention provides a device with hinged USB connector, in which electric power or data is supplied via a computer to the USB connector, thereby providing power or data to the device which is connected to the USB connector in a hinged manner.

To attain this, the present invention is a device with hinged USB connector, wherein one or more ends of the device are connected to a USB connector in a hinged manner.

At the foldable end of the device, there is a recess in the centre which forms a receiving slot. On each of the two sides of the receiving slot, there is an insertion hole respectively for insertion of a hinge shaft. The USB connector has an integrally formed protruding part, the shape and position of which correspond to the receiving slot. The protruding part is inserted into the receiving slot and has a through hole in position corresponding to the insertion holes of the receiving slot for insertion of the hinge shaft. The hinge shaft connects the USB connector and the device in a hinged manner.

Alternatively, at the foldable end of the USB connector which connects to the device, there is a recess in the centre which forms a receiving slot. On each of the two sides of the receiving slot, there is an insertion hole respectively for insertion of a positioning pin. The device has an integrally formed protruding part, the shape and position of which correspond to the receiving slot. The protruding part has the positioning pin protruding therefrom in position corresponding to the insertion holes of the receiving slot. The protruding part is inserted into the receiving slot with the positioning pin inserted into the insertion holes. The positioning pin connects the USB connector and the device in a hinged manner.

As an alternative, the two ends of the device are connected to the USB connector and a functional device respectively in a hinged manner by means of a hinged device.

At each of the two ends of the device, there is a recess in the centre which forms a receiving slot. On each of the two sides of the receiving slot, there is an insertion hole respectively for insertion of a hinge shaft. Each of the USB connector and the functional device has an integrally formed protruding part, the shape and position of which correspond to the respective receiving slot. Each protruding part is inserted into the respective receiving slot and has a through hole in position corresponding to the respective insertion hole of the receiving slot for insertion of the respective hinge shaft. The hinge shafts connect the USB connector and the functional device respectively to the device in a hinged manner.

As a further alternative, at the foldable end of the USB connector which connects to the device, there is a recess in the centre which forms a receiving slot. At the foldable end of the functional device which connects to the device, there is also a recess in the centre which forms a receiving slot. On each of the two sides of the respective receiving slot, there is an insertion hole respectively for insertion of a positioning pin. At each end of the device, there is an integrally formed protruding part, the shape and position of which correspond to the receiving slot of the USB connector or the receiving slot of the functional device respectively. The protruding part has the positioning pin protruding therefrom in position corresponding to the insertion holes of the respective receiving slot. The protruding part is inserted into the receiving slot with the positioning pin inserted into the insertion holes. The positioning pins connect the USB connector and the functional device respectively to the device in a hinged manner.

A further alternative is that at one end of the device, there is a recess in the centre which forms a receiving slot. At the end of the USB connector which is connected to the device in a hinged manner, there is an integrally formed protruding part, the shape and position of which correspond to the receiving slot. At the other end of the device, there is an integrally formed protruding part, the shape and position of which correspond to the receiving slot of the functional device, which is connected to the device in a hinged manner. Each protruding part has a positioning pin protruding therefrom in position corresponding to the insertion holes of the respective receiving slot. The protruding parts are inserted into the respective receiving slots with the respective positioning pins inserted into the insertion holes. The positioning pins connect the USB connector and the functional device respectively to the device in a hinged manner.

Connecting cables pass through the through holes of the hinge shaft or the positioning pin and connect to the USB connector and the device respectively.

The device is a lighting device, UBS drive, MP3, blue-tooth device, anion generator, charger or mini digital camera.

It is an object of the present invention to provide a device with hinged USB connector, in which electric power or data is supplied via a computer to the USB connector, thereby providing power or data to the device which is connected to the USB connector in a hinged manner, and the device is of simple and reliable construction and is convenient to use and carry, thus overcoming the disadvantages of the prior art.

It is another object of the present invention to provide a device with hinged USB connector and when it is used as a lighting device, the head of the lamp is rotatable to adjust the angle of illumination at an angle of over 180° and to achieve the best angle of illumination. It can serve as a USB chargeable lamp for night illumination.

An even further object of the present invention is to provide a device with hinged USB connector and when it is used as a lighting device, a control circuit is incorporated to indicate the charging status of the battery, thus providing protection to the device.

### BRIEF DESCRIPTION OF THE DRAWINGS

FIG. 1 is a view of the first embodiment of the present invention.

FIG. 2 is a view of the second embodiment of the present invention.

FIG. 3 is a view of the third embodiment of the present invention.

FIG. 4 is a view of the fourth embodiment of the present invention.

FIG. 5 is a view of the fifth embodiment of the present invention.

FIG. 6 is a side view of the device of FIG. 3.

FIG. 7 is a side view of the device of FIG. 3 when it is in use.

### DETAILED DESCRIPTION OF THE INVENTION

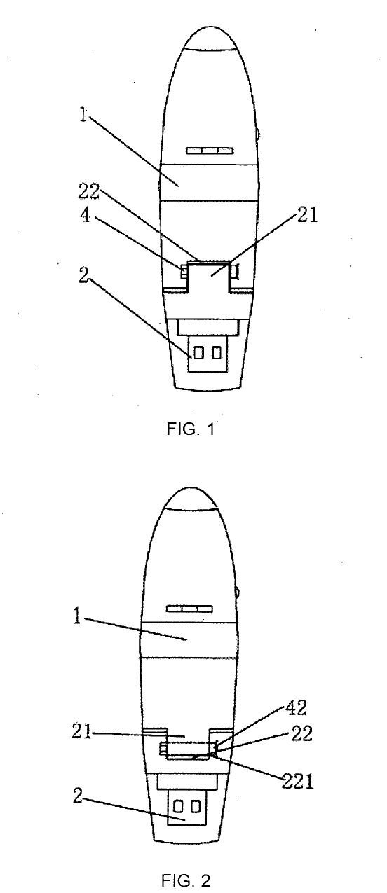

FIG. 1 shows the first embodiment of the present invention, which is an application in the form of a USB drive device or MP3. At the foldable end of the USB drive device or MP3 1, there is a recess in the centre which forms a receiving slot 22. On each of the two sides of the receiving slot 22, there is an insertion hole respectively for insertion of a hinge shaft 4. A USB connector 2 has an integrally formed protruding part 21, the shape and position of which correspond to the receiving slot 22. The protruding part 21 is inserted into the receiving slot 22 and has a through hole in position corresponding to the insertion holes of the receiving slot 22 for insertion of the hinge shaft 4. The hinge shaft 4 connects the USB connector 2 and the USB drive device or MP3 1 in a hinged manner. Data cables pass through the through holes of the hinge shaft 4 and connect to the USB connector 2 and the USB drive device or MP3 1 respectively.

FIG. 2 shows the second embodiment of the present invention, which is an application in the form of a blue-tooth device or mini digital camera. At the foldable end of a USB connector 2 which connects to the blue-tooth device or mini digital camera 1, there is a recess in the centre which forms a receiving slot 22. On each of the two sides of the receiving slot 22, there is an insertion hole 221 respectively for insertion of a positioning pin 42. The blue-tooth device or mini digital camera 1 has an integrally formed protruding part 21, the shape and position of which correspond to the receiving slot 22. The protruding part 21 has the positioning pin 42 protruding therefrom in position corresponding to the insertion holes 221 of the receiving slot 22. The protruding part 21 is inserted into the receiving slot 22 with the positioning pin 42 inserted into the insertion holes 221. The positioning pin 42 connects the USB connector 2 and the blue-tooth device or mini digital camera 1 in a hinged manner. Connecting cables pass through the through holes of the positioning pin 42 and connect to the USB connector 2 and the blue-tooth device or mini digital camera 1 respectively.

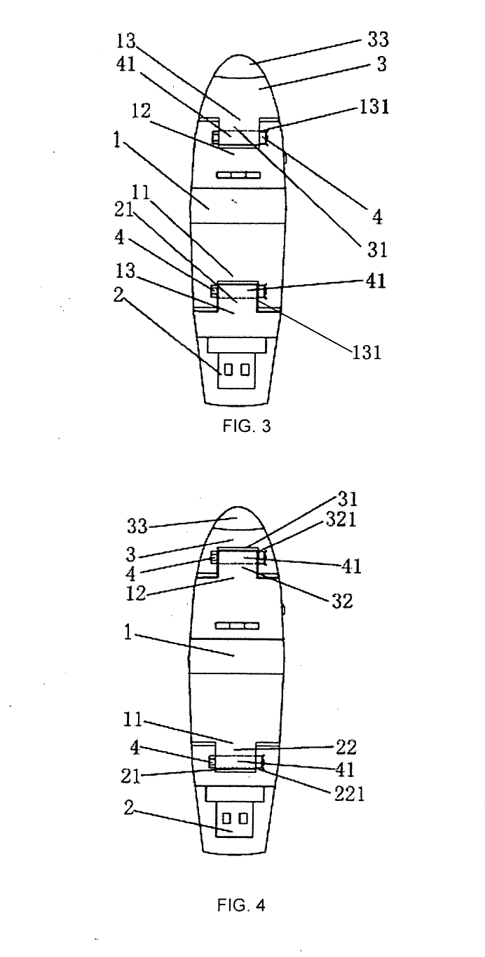

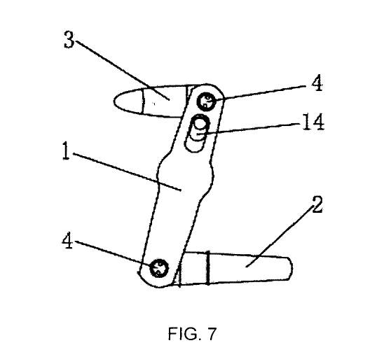

FIG. 3, FIG. 6 and FIG. 7 show the third embodiment of the present invention, which is an application in the form of a USB chargeable lamp. One end 11 of the battery charger 1 of the USB chargeable lamp connects to a USB connector 2 in a hinged manner. The other end 12 of the battery charger 1 connects to a lighting device 3 in a hinged manner. At each end of the battery charger 1, there is a recess in the centre which forms a receiving slot 13. On each of the two sides of the receiving slot 13, there is an insertion hole 131 respectively for insertion of a hinge shaft 4. Each of the USB connector 2 and the lighting device 3 has an integrally formed protruding part 21, 31, the shape and position of which correspond to the respective receiving slot 13. Each protruding part 21, 31 is inserted into the respective receiving slot 13 and has a through hole 41 in position corresponding to the respective insertion hole 131 of the receiving slot 13 for insertion of the respective hinge shaft 4. The hinge shafts 4 connect the USB connector 2 and the lighting device 3 respectively to the battery charger 1 in a hinged manner. Near the lighting device 3, on the outside surface of the battery charger 1, there is a switch 14. At the end of the lighting device 3, there is a lampshade 33 which is made of transparent plastic material. A LED lamp (not shown in the figures) is put in the bulb holder inside the lighting device 3. Connection cables pass through the through holes of the hinge shaft 4 and connect to the USB connector 2 and the lighting device 3 respectively.

To use the device, the user first removes the cover of the USB connector and plugs the USB connector 2 in a USB port of a computer. The rechargeable battery inside the present invention is then charged through the DC power source of the computer and the signal light indicates the charging status. After finishing charging, the user unplugs the present invention from the USB port of the computer. According to the practical needs, the user adjusts the rotation angle of the USB socket 2 and that of the lighting device 3 respectively and fixes the position. The user switches on the lamp by turning the switch of the lamp to the “ON” state. The head of the lamp is rotatable to adjust the best angle of illumination. After use, the user places the cover back onto the USB connector.

FIG. 4 shows the fourth embodiment of the present invention, which is an application in the form of an anion generator. One end 11 of the anion generator 1 connects to a USB connector 2 in a hinged manner. The other end 12 of the anion generator 1 connects to a discharging outlet 3 in a hinged manner. On the respective end of the USB connector 2 or the discharging outlet 3 which faces the respective end of the anion generator 1, there is a recess in the centre which forms a receiving slot 22, 32. On each of the two sides of the respective receiving slot 22, 32, there is an insertion hole 221, 321 respectively for insertion of a positioning pin 4. At each end of the anion generator 1, there is an integrally formed protruding part 21, 31, the shape and position of which correspond to the receiving slot 22, 32 of the USB connector 2 and the discharging outlet 3 respectively. Each protruding part 22, 32 is inserted into the respective receiving slot 22, 32 and has a through hole 41 in position corresponding to the respective insertion hole 221, 321 of the receiving slot 22, 32 for insertion of the respective positioning pin 4. The positioning pin 4 connect the USB connector 2 and the discharging outlet 3 respectively to the anion generator 1 in a hinged manner. Gas transmitting conduits pass through the through holes of the hinge shafts 4 and connect to the anion generator 1 and the discharging outlet 3 respectively.

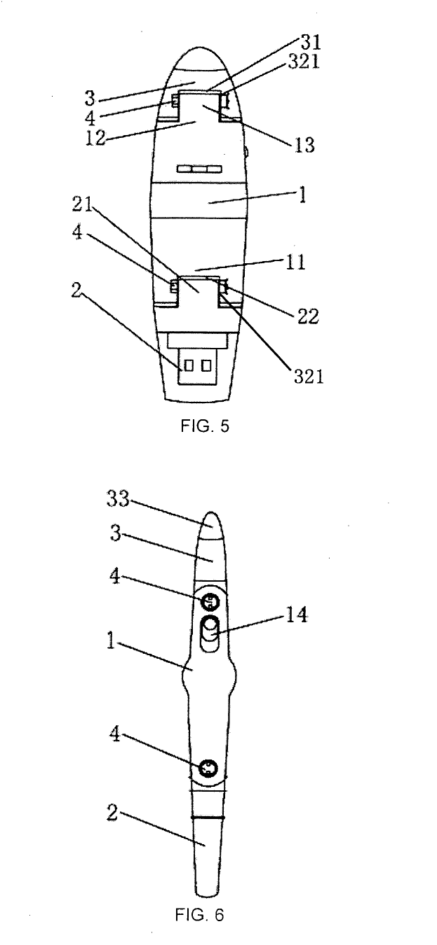

FIG. 5 shows the fifth embodiment of the present invention, which is an application in the form of a charger. At one end 11 of the charger 1, there is a recess in the centre which forms a receiving slot 22. At the end of a USB connector 2 which is connected to the charger 1 in a hinged manner, there is an integrally formed protruding part 21, the shape and position of which correspond to the receiving slot 22. At the other end 12 of the charger 1, there is an integrally formed protruding part 13, the shape and position of which correspond to the receiving slot 31 of an electric socket 3, which is connected to the charger 1 in a hinged manner. Each of the protruding part 13, 21 has a positioning pin 4 protruding therefrom in position corresponding to the insertion holes 321 of the respective receiving slot 31, 22. Each of the protruding part 13, 21 is inserted into the respective receiving slot 31, 22 with the respective positioning pins 4 inserted into the insertion holes 321. The positioning pins 4 connect the USB connector 2 and the electric socket 3 respectively to the charger 1 in a hinged manner. Connection cables pass through the through holes of the positioning pins 4 and connect to the USB connector 2 and the charger 1 respectively.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A device with hinged USB connector, wherein one or more ends of the device are connected to a USB connector in a hinged manner.

2. The device with hinged USB connector as in claim 1, wherein at the foldable end of the device, there is a recess in the centre which forms a receiving slot; on each of the two sides of the receiving slot, there is an insertion hole respectively for insertion of a hinge shaft; the USB connector has an integrally formed protruding part, the shape and position of which correspond to the receiving slot; the protruding part is inserted into the receiving slot and has a through hole in position corresponding to the insertion holes of the receiving slot for insertion of the hinge shaft; and the hinge shaft connects the USB connector and the device in a hinged manner.

3. The device with hinged USB connector as in claim 1, wherein at the foldable end of the USB connector which connects to the device, there is a recess in the centre which forms a receiving slot; on each of the two sides of the receiving slot, there is an insertion hole respectively for insertion of a positioning pin; the device has an integrally formed protruding part, the shape and position of which correspond to the receiving slot; the protruding part has the positioning pin protruding therefrom in position corresponding to the insertion holes of the receiving slot and the protruding part is inserted into the receiving slot with the positioning pin inserted into the insertion holes; and the positioning pin connects the USB connector and the device in a hinged manner.

4. The device with hinged USB connector as in claim 1, wherein the two ends of the device are connected to the USB connector and a functional device respectively in a hinged manner by means of a hinged device.

5. The device with hinged USB connector as in claim 1, wherein at each of the two ends of the device, there is a recess in the centre which forms a receiving slot; on each of the two sides of the receiving slot, there is an insertion hole respectively for insertion of a hinge shaft; each of the USB connector and the functional device has an integrally formed protruding part, the shape and position of which correspond to the respective receiving slot; each protruding part is inserted into the respective receiving slot and has a through hole in position corresponding to the respective insertion hole of the receiving slot for insertion of the respective hinge shaft; and the hinge shafts connect the USB connector and the functional device respectively to the device in a hinged manner.

6. The device with hinged USB connector as in claim 1, wherein at the foldable end of the USB connector which connects to the device, there is a recess in the centre which forms a receiving slot; at the foldable end of the functional device which connects to the device, there is also a recess in the centre which forms a receiving slot; on each of the two sides of the respective receiving slot, there is an insertion hole respectively for insertion of a positioning pin; at each end of the device, there is an integrally formed protruding part, the shape and position of which correspond to the receiving slot of the USB connector or the receiving slot of the functional device respectively; the protruding part has the positioning pin protruding therefrom in position corresponding to the insertion holes of the respective receiving slot; the protruding part is inserted into the receiving slot with the positioning pin inserted into the insertion holes; and the positioning pins connect the USB connector and the functional device respectively to the device in a hinged manner.

7. The device with hinged USB connector as in claim 1, wherein at one end of the device, there is a recess in the centre which forms a receiving slot; at the end of the USB connector which is connected to the device in a hinged manner, there is an integrally formed protruding part, the shape and position of which correspond to the receiving slot; at the other end of the device, there is an integrally formed protruding part, the shape and position of which correspond to the receiving slot of the functional device, which is connected to the device in a hinged manner; each protruding part has a positioning pin protruding therefrom in position corresponding to the insertion holes of the respective receiving slot and the protruding parts are inserted into the respective receiving slots with the respective positioning pins inserted into the insertion holes; and the positioning pins connect the USB connector and the functional device respectively to the device in a hinged manner.

8. The device with hinged USB connector as in claim 1, wherein connecting cables pass through the through holes of the hinge shaft or the positioning pin and connect to the USB connector and the device respectively.

9. The device with hinged USB connector as in claim 1, wherein the device is a lighting device, UBS drive, MP3, blue-tooth device, anion generator, charger or mini digital camera.
